(19) United States
(12) Patent Application Publication
(10) Pub. No.: US 2007/0065651 A1
(43) Pub. Date: Mar. 22, 2007

(54) Articles with protruding conductive coatings

(76) Inventors: Paul J. Glatkowski, Littleton, MA (US); Joseph W. Piche, Raynham, MA (US); Masato Sakai, Osaka (JP); Hidemi Ito, Osaka (JP)

Correspondence Address: NOVAK DRUCE & QUIGG, LLP, 1300 EYE STREET NW, SUITE 1000 WEST TOWER, WASHINGTON, DC, 20005, US

(21) Appl. No.: 10/542,786

(22) PCT Filed: Jan. 29, 2004
(86) PCT No.: PCT/US04/02319

§ 371 Date: Aug. 2, 2006

(30) Foreign Application Priority Data
Jan. 30, 2003 (JP) 2003-21538

(51) Int. Cl. B32B 27/04; B32B 18/00; B05D 1/12

(52) U.S. Cl. 428/297.4; 428/299.1; 427/180

(57) ABSTRACT

A conductive article includes a substrate and a conductive layer that is formed on the surface of the substrate and contains fine conductive fibers that are dispersed in the conductive layer. One end of the fibers is fixed to the substrate and other end of the fibers protrude from the top surface of the conductive layer. Alternatively, a middle portion of the fibers may protrude from the top surface or fixed to the substrate. Even though the fibers are dispersed well enough to avoid the aggregation of the fibers, portions of the fibers are located close to each other enough to provide electrical contact.

### BACKGROUND OF THE INVENTION

1. Field of the Invention

This invention relates to conductive articles that have a conductive layer formed from ultra fine conductive fibers dispersed on a surface of a substrate, and in particular, wherein the conductive fibers are carbon nanotubes. The invention further relates to methods for forming such conductive articles.

2. Description of the Background

An anti-electrostatic resin plate that is able to release static electricity and avoid dust adherence has been used for clean room partitions as well as for barrels of devices and windows used in clean rooms. One such example is described in Japanese Laid Open Patent Publication 2001-62952. The resin material of this invention includes tangled fibers that would extend at the time of article formation to provide a good conductivity.

A substrate film, where ITO (Indium Tin Oxide) or ATO (Antimony Tin Oxide) with antimony doped is placed on the surface, has been known as a transparent conductive film with a surface resistivity of 10⁰ to 10⁵Ω/□ (Japanese Laid Open Paten Publication 2003-151358).

In the conventional anti-electrostatic transparent resin plate (Japanese Laid Open Paten Publication 2001-62952), the carbon fibers bent and intertwined with each other are buried in an anti-electrostatic layer. Therefore, the carbon fibers are not well dispersed. The amount of the carbon fiber in the anti-electrostatic layer should be increased in order to achieve an adequate surface resistivity of 10⁵ to 10⁸Ω/□. The anti-electrostatic transparent resin plate mentioned above can acquire an electromagnetic shield property when the amount of the carbon fiber in the anti-electrostatic layer is further increased and the surface resistivity is reduced to 10⁴Ω/□. However, the transparency of the anti-electrostatic layer is deteriorated when the amount of the carbon fiber is increased. Thus, it is difficult to acquire the practical anti-electrostatic transparent resin plate that has both a good transparency and electromagnetic shield property.

The transparent conductive film described in the Japanese Laid Open Paten Publication 2003-151358 is formed through a batch method such as spattering. Therefore, it has a poor productivity and the high production cost.

This invention is directed to solve the problems mentioned above. That is, this invention is directed to form the article with the conductive layer with a good conductivity even with the decreased amount of the ultra fine conductive fiber such as carbon fiber. This invention is also directed to form the article with the conductive layer, which has a good conductivity, with the same amount of the ultra fine conductive fiber such as carbon fiber as that of the conventional art. Also, this invention is directed to forming the article with a transparent conductive layer that can be produced with low production cost.

### SUMMARY OF THE INVENTION

As embodied and broadly described herein, the present invention is directed to articles that have a conductive layer on a surface of a substrate.

One embodiment of the invention is directed to conductive articles comprising a substrate and a conductive layer formed on a surface of the substrate and comprising fine conductive fibers dispersed in the conductive layer, wherein a portion of at least some of the fibers is fixed to the substrate and another portion of some of the fibers protrude from a top surface of the conductive layer, and the fibers are arranged to be electrically in contact with each other. Preferably, fibers are electrically in contact each other at the portions protruding form the top surface or at the portions fixed to the substrate.

The substrate comprises a substrate body and a surface layer, wherein the portions of the fibers fixed to the substrate are fixed to the surface layer, or the portion of the fibers fixed to the substrate are an end part of the fibers or a middle part of the fibers. Preferably, fibers are separated from other fibers, and form a plurality of bundles, wherein fiber bundles are separated from other. Preferred fibers include, but are not limited to carbon fibers, and preferred carbon fibers are carbon nanotubes. Conductive layers can be of preferred thicknesses of from 5 to 500 nm. Preferred surface layers are formed of a curable resin, such as a surface layer formed of a thermoplastic resin. Preferred conductive articles have a surface resistivity of between about 10⁰ and about 10¹¹Ω/□. Preferably the articles have a 550 nm light transmittance of at least 50% wherein and a surface resistivity of from 10⁰ to 10⁵Ω/□.

Other embodiments and advantages of the invention are set forth in part in the description, which follows, and in part, may be obvious from this description, or may be learned from the practice of the invention.

### DESCRIPTION OF THE DRAWINGS

FIG. 1 is a cross-sectional view of an embodiment of the conductive article of this invention.

FIG. 2 is a partial enlarged cross-sectional view of the conductive article of FIG. 1.

FIG. 3 is a plan diagram of the conductive layer of FIG. 1 showing the dispersion of the ultra fine conductive fiber.

FIG. 4 is a partial enlarged cross-sectional view showing that the ultra fine conductive fiber is fixed with the binder.

FIG. 5 is a partial enlarged cross-sectional view of another embodiment of the conductive article of this invention.

FIG. 6 is a transmission electron microscopic photograph showing the protrusion of the ultra fine conductive fiber viewing from the cross-section of the conductive layer of the article of conductive coating of the example 1 of this invention.

FIG. 7 is a scanning electron microscopic photograph showing the structure of the ultra fine conductive fiber viewing the conductive layer of the article of conductive coating of the example 2 of this invention from above.

FIG. 8 is a scanning electron microscopic photograph, which shows that the ultra fine conductive fiber does not protrude, viewing from the cross-section of the conductive layer of the comparative example 1.

### DESCRIPTION OF THE INVENTION

As embodied and broadly described herein, the present invention is directed to conductive articles that optionally may be transparent conductive layers, and methods of forming such articles.

One embodiment of the invention is directed to articles that comprise a conductive layer made of well-dispersed ultra fine conductive fibers. A characteristic of this invention is that a part of the fiber is fixed to the substrate and another part is protruding from the substrate, wherein fibers are in contact with each other. The word “protruding” is used to denote the incomplete protrusion of the fibers, i.e., the ultra fine conductive fiber is exposed from the surface of the substrate. Also, the word “conductive” is used to denote a broad range of the surface resistivity of 10⁰ to 10¹¹Ω/□.

The parts of the ultra fine conductive fiber fixed to the substrate as well as the parts of the fiber protruding from the substrate should be in contact with each other in the conductive article of this invention. It is also possible that the substrate is made from a substrate main body and a surface layer. The part of the ultra fine conductive fiber can also be fixed to the surface layer. It is preferable that the ultra fine conductive fibers, or bundle of the fibers are in contact with each other and yet dispersed so that each fiber is separated from other fibers or bundle of the fiber, where a plurality of the fibers make a bundle, is separated from other bundles. It is preferable that the ultra fine fiber is carbon fiber, especially carbon nanotube. It is also preferable that the thickness of the conductive layer is 5 to 500 nm and that the surface layer is made of hardening resin or thermo-plastic resin. Also, the article is transparent and the surface resistivity be 100 to 10¹¹Ω/□. The light transmission of the light with 550 nm wavelength of the conductive layer is above 50% and the surface resistivity of the conductive layer is 10⁰ to 10¹¹Ω/□.

The dispersion of the carbon fiber is poor and the frequency of contacts by the fibers is low when the carbon fiber, which is bent and intensely intertwined each other, is included in the anti-electrostatic layer made of thermo-plastic resin as in the case of the conventional anti-electrostatic resin plate. Additionally, when the carbon fiber is contained in the thermo-plastic resin with an electro-insulating property, the thermoplastic resin prevents the flow of electricity, increasing the surface resistivity. Therefore, it has the far greater surface resistivity compared to that of the layer only with the carbon fibers intertwined each other.

The conductive article of this invention has the conductive layer made of the fiber, where a part of the ultra fine conductive fiber is fixed to the substrate and other part of the fiber is protruding from the substrate. The fibers are in contact with each other. There is no obstacle for the flow of electricity at the location where the ultra fine conductive fiber of the conductive layer is protruding from the substrate other than the ultra fine conductive fiber. Therefore, conductive article of this invention has an excellent conductivity. It shows the better conductivity when the same amount of the ultra fine conductive fiber as the conventional art is included. Also, it can achieve the improved conductivity even with the smaller amount of the ultra fine conductive fiber. The conductivity is further improved when the ultra fine conductive fibers are in contact and yet dispersed so that each fiber is separated from other fibers or each bundle of the fiber, where a plurality of the fibers make a bundle, is separated from other bundles, since it increases the frequency for the fiber to make contacts with each other. The transparency is also improved when the amount of the ultra fine conductive fiber to be contained is lowered, also improving the transparency of the substrate.

The conductive article of this invention has the conductive layer made of the dispersed ultra fine conductive fiber, where a part of the ultra fine conductive fiber is fixed to the substrate. Therefore, the peeling-off of the conductive layer due to the separation of the fiber from the substrate does not take place, preventing the deterioration of the conductivity after a long time usage.

The conductive article of this invention can also be produced continuously and efficiently, improving the productivity. That is, the production cost can be lowered compared to the forming of ITO film and ATO film by the batch method such as vacuum evaporation and spattering.

Preferred embodiments of the invention may be explained by referring to figures. However, this invention is not limited to those embodiments.

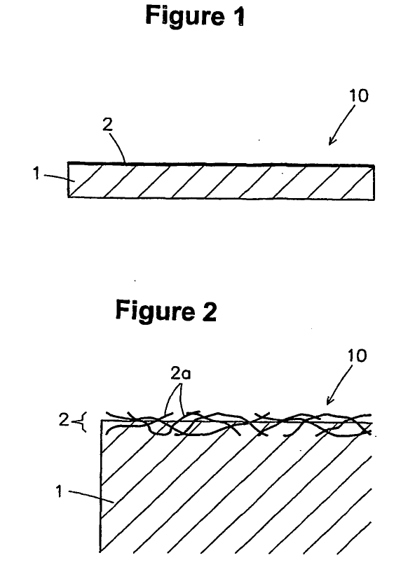

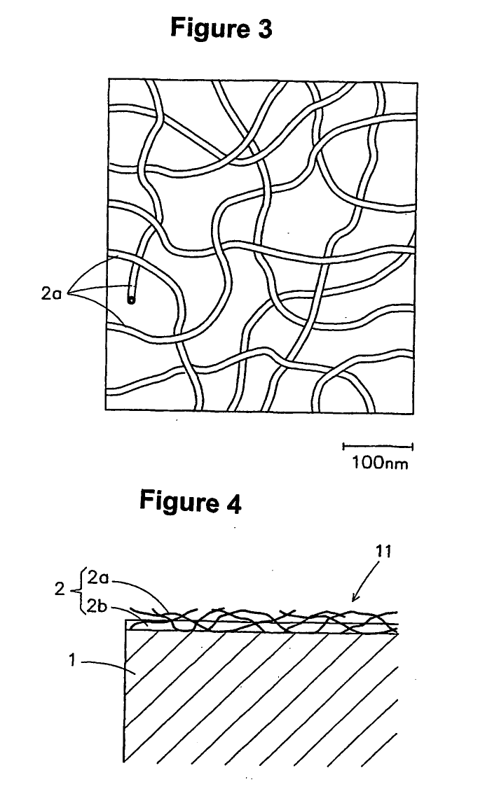

FIG. 1 is a cross-sectional view of the conductive article of an embodiment of this invention. FIG. 2 is an enlarged partial view of the conductive article, and FIG. 3 is a plan diagram showing the dispersion of the ultra fine conductive fiber of the conductive layer.

The conductive article 10 has the transparent layer 2 made of the ultra fine carbon fiber dispersed on the surface of the substrate 1. The conductive layer 2 can be formed both upper and bottom surfaces of the substrate 1.

The substrate 1 is made of thermoplastic resin, hardening resin that is hardened by the application of heat, ultra-violet ray, electric beam or radioactive ray, glass, ceramics, or inorganic material. The substrate 1 made of the transparent thermo-plastic resin, hardening resin, or glass is desirable for acquiring the transparent conductive article 10. The transparent thermo-plastic resin includes, for example, olefin resin such as polyethylene, polypropylene, and ring polyolefin, vinyl resin such as polyvinylchloride, polymethylmethacrylate, and polystyrene, cellulose resin such as nitrocellulose and triacetylcellulose, ester resin such as polycarbonate, polyethyleneterephtalate, polydimethylcyclohexeneterephtalate, and aromaticpolyester, ABS resin, the co-polymer and the mixture of these resins. The transparent hardening resin includes epoxy resin and polyimid resin.

The transparent resin, which has the light transmission of above 75% (preferably above 80%) and the haze of below 5% when the thickness of the substrate 1 is 3 mm, is especially desirable among the transparent resin mentioned above. Since glass has the excellent light transmission of above 95%, glass is used frequently for acquiring the transparent conductive article 10.

Plasticizer, stabilizer and ultra-violet ray absorbent should be added when the substrate 1 is made of the thermo-plastic resin or the hardening resin in order to improve the ease of forming, the thermo-stability and the durability against weathering. The substrate 1 can also be made opaque or semi-opaque by adding die or pigment. In this case, an opaque or a semi-opaque conductive article 10 is acquired. Since the conductive layer 2 is transparent, the color of the die or pigment can be kept intact.

The form of the substrate 1 is not limited to a plate as shown in FIG. 1. The thickness of the substrate 1 should be determined according to the usage, but the thickness of the substrate is usually about 0.03 to 10 mm when the substrate is formed as a plate.

The conductive layer 2 formed on the surface of the substrate 1 is the layer made of the dispersed ultra fine conductive fiber 2a as shown in FIG. 2. A part of the ultra fine conductive fiber 2a is fixed to the substrate 1 and other part of the fiber is protruding from the substrate, and yet the ultra fine conductive fibers 2a are in contact with each other. FIG. 3 shows a protruding end of a fiber of the conductive article of FIG. 1 in a plan view. However, not all the ultra fine conductive fibers 2a should be fixed on the substrate 1 or be protruding from the substrate 1. That is, some parts of the ultra fine conductive fiber 2a can be buried in the substrate 1 All the ultra fine conductive fibers 2a are protruding from the substrate 1 in FIG. 2, but it is also acceptable for the ultra fine conductive fiber to be exposed from the surface of the substrate 1. It is desirable, however, that the fiber is protruding from the surface in order to achieve the better conductivity.

A part of the ultra fine conductive fiber 2a of the conductive article 11 should be bound to the surface of the substrate 1 by a binder layer 2b as shown in FIG. 4. The location of the binding can be at the middle or at the edge of the ultra fine conductive fiber 2a. The transparent thermo-plastic resin (polyvinylchloride, co-polymer between vinyl chloride and vinyl acetate, polymethylmethacrylate, nitrocellulose, chlorinated polyethylene, chlorinated polypropylene, and fluorovinylidene) and the transparent hardening resin that is hardened by the application of heat, ultra-violet ray, electric beam or radioactive ray (melamine acrylate, urethane acrylate, epoxy resin, polyimid resin, and silicon resin such as acryl-transformer silicate) are used as a binder. Also, inorganic material such as colloidal silica can be added to the material for the binder. When the substrate 1 is made of transparent thermoplastic resin, the same transparent thermoplastic resin or the different transparent thermoplastic resin with the mutual-solubility is preferably used as a binder, because they improve the binding strength of the ultra fine conductive fiber 2a.

The binding method of the ultra fine conductive fiber 2a is not limited to the usage of the binder layer mentioned above. For example, a part of the fiber 2a can be buried directly to the substrate 1, as shown in FIG. 2.

The ultra fine conductive fiber 2a forming the conductive layer 2 is dispersed equally on the surface of the substrate 1. The fiber or bundle of the fiber, where a plurality of the fibers makes a bundle, is in contact with each other and yet separated from other fibers or bundles. That is, the ultra fine conductive fiber 2a is in contact with each other and yet dispersed so that each fiber is separated from other fibers or each bundle is separated from other bundles. The fibers are not densely concentrated or intensely intertwined with each other. The fibers are simply crossing each other, making contact at the location of the crossing and dispersed equally on the surface. Therefore, the frequency for the ultra fine conductive fiber to make contact with each other is high, achieving the excellent conductivity. The location, where the ultra fine conductive fibers 2a are in contact with each other, can be at the protruding part, the fixed part, or the both parts of the fiber.

Ultra fine carbon fiber such as carbon nanotube, carbon nanohorn, carbon nanowire, carbon nanofiber, and graphite fibril, ultra fine metal fiber such as metal nanotube and metal nanowire made of platinum, gold, silver, nickel, and silicon, and ultra fine metal oxide fiber such as metal oxide nanotube or metal oxide nanowire made of zinc oxide are used for the ultra fine conductive fiber 2a. The fiber with the diameter of 0.3 to 100 nm and the length of 0.1 to 20 μm, especially 0.1 to 10 μm is preferably used. Carbon nanotube has a very small diameter of 0.3 to 80 μm and a large aspect ratio among the ultra fine conductive fibers. Therefore, there are very few obstacles for light transmission, achieving the transparency of the conductive layer. Furthermore, the small surface resistivity is acquired.

The carbon nanotube mentioned above includes multi-layered carbon nanotube and single-layered carbon nanotube. There is a plurality of tubes made of carbon walls with different diameters enclosed around the shared center axis in the multilayered carbon nanotube. The carbon walls are configured as hexagonal stacking structure. Some multi-layered carbon nanotube has a carbon wall spiral that forms a plurality of layers. The desirable multi-layered carbon nanotube has 2 to 30 carbon wall layers, preferably 2 to 15 carbon wall layers. The multi-layered carbon nanotube described above can make the conductive layer 2 with an excellent light transmission. Usually multi-layered carbon nanotube is dispersed with each piece of the carbon nanotube separated from each other. However, in some cases, the 2 to 3 layered carbon nanotubes form bundles, which are dispersed as described above.

The single-layered carbon nanotube has a single enclosed carbon wall around the center axis. The carbon wall is configured as hexagonal stacking structure. The single-layered carbon nanotube is not easily dispersed piece by piece. Two or more tubes form a bundle, and bundles are intertwined with each other. However, the bundles are not densely concentrated or intensely intertwined with each other. The bundles are simply crossing each other, making contact at the location of the crossing and dispersed equally on the surface. The preferable bundle of the single-layered carbon nanotube has 10 to 50 tubes. However, this invention does not exclude the single-layered carbon nanotube dispersed piece by piece separated from each other.

The ultra fine conductive fiber 2a is dispersed as describes above on the surface of the substrate 1. The part of the fiber is fixed on the surface of the substrate 1 and other part of the fiber is protruding from the surface of the substrate 1. The frequency of contacts by the ultra fine conductive fibers 2a is high when the conductive layer 2 is formed in this way. Additionally, the ultra fine conductive fiber 2a has an excellent conductivity since there is no obstacle for the flow of electricity at the location where the ultra fine conductive fiber is protruding from the substrate 1 other than the ultra fine conductive fiber. Therefore, the conductive layer 2 with a broad range of the surface resistivity of 10⁰ to 10¹¹Ω/□ can be acquired by adjusting the estimated content of the ultra fine conductive fiber 2a.

For example, the estimated content of the fiber is adjusted to 1.0 to 450 mg/m² to form the conductive layer 2 with the surface resistivity of 10⁰ to 10¹¹Ω/□ when the ultra fine conductive fiber 2a is made of ultra fine carbon fiber such as carbon nanotube. The conductive layer 2 has the light transmission of at least 50% with the estimated content mentioned above. The estimated content can be obtained by following the steps described below. First, observe the conductive layer 2 by an electron microscopy, measuring the area occupied by the ultra fine conductive fiber in the plan area. Then, observe and measure the thickness of the conductive layer. Then, multiply the fiber area by the thickness of the conductive layer acquired from the electro microscopic observation and the specific gravity of ultra fine conductive fiber (value 2.2, the average of 2.1 to 2.3, reported as the specific gravity of graphite is used when the ultra fine conductive fiber is made of carbon nanotube). Also the light transmission is the value of the light transmission rate of the light with the wavelength of 550 nm measured by a spectroscope.

The conventional conductive layer, which has ultra fine carbon fiber of the estimated content mentioned above in the transparent thermo-plastic resin, has a low frequency of contacts by the fibers, and the thermo-plastic resin works to prevent the flow of electricity. Therefore, the conventional conductive layer has a high surface resistivity compared to the conductive layer 2 of this invention, where the ultra fine carbon fiber is dispersed as described above.

The conductive layer 2 made of the dispersed ultra fine conductive fiber 2a has the surface resistivity of 10⁰ to 10¹¹Ω/□. Since it has an excellent conductivity and anti-electrostatic property, it can achieve the same or the better conductivity and anti-electrostatic property as or than that of the conventional conductive layer even if the estimated content of the ultra fine conductive fiber 2a is reduced to improve the transparency of the conductive layer 2. Since a part of the fiber 2a is fixed to the substrate 1, the peeling-off of the conductive layer 2 due to the separation of the fiber 2a from the substrate 1 does not take place, preventing the deterioration of the conductivity after long time usage.

The conductive layer described above can be formed by the following methods. In the first method, the binder for fixing the ultra fine conductive fiber is solved into a volatile solvent. The ultra fine conductive fiber 2a is equally dispersed in this solution, making a coating solution, which is then applied to the substrate 1. The conductive layer 2 is obtained by drying the coating solution on the substrate 1, forming the conductive article 10. Since the coating solution is applied to and then dried on the surface, the volume of the coating solution is decreased. Therefore, the binder is hardened with the ultra fine conductive fiber protruding from the surface when the quantity of the binder is smaller than that of the ultra fine conductive fiber, forming the desirable conductive layer 2.

In the second method, the binder for fixing the ultra fine conductive fiber is solved into a volatile solvent. The ultra fine conductive fiber 2a is equally dispersed in this solution, making a coating solution, which is then applied to the substrate 1. Heat is applied, after the solution is dried, to soften the binder slightly extending it according to the necessity. The conductive layer 2 is obtained, forming the conductive article 10. The ultra fine conductive fiber, which has been shrunk upon the drying, protrudes from the binder with its spontaneous force of spring back when the binder is softened with the application of heat. The desirable conductive layer 2 can be obtained by this method. The extension of the binder helps the ultra fine conductive fiber protrude.

In the third method, the ultra fine conductive fiber 2a is equally dispersed in a volatile solvent, making a coating solution. Then, the coating solution is applied to and dried on a peeling-off film made of polyethyleneterephtalate and dried, making the conductive layer 2. Then, an adhesive layer is formed on the conductive layer 2, forming a three-layered transfer film. The transfer film is pressed on the surface of the substrate 1, transferring the adhesive layer and the conductive layer 2. The conductive article is obtained. The binder is not included in the solution in this method. Therefore, only the layer of the ultra fine conductive fiber 2a is formed on the surface of the conductive article 10, acquiring the desirable conductive layer 2. It is also possible to add a small amount of the binder to the solution.

In the forth method, the ultra fine conductive fiber 2a is equally dispersed in a volatile solvent, making a coating solution. Then the coating solution is applied to and dried on the substrate, making the conductive layer 2. Then, the solution containing the binder is applied to the conductive layer 2, obtaining the conductive article 10. Since the solution containing the binder goes through the conductive layer 2 and reaches the substrate 1 in this method, the conductive layer 2 is not covered with the binder, achieving the desirable conductive layer 2.

The substrate 1 made of resin film is continuously fed and the coating solution is continuously applied to the surface of the substrate 1 by the rolling coater in those methods described above. The methods described above are very efficient. They can improve the productivity and reduce the production cost, compared to the conventional batch method.

In the fifth method, the ultra fine conductive carbon fiber 2a is sprayed and a part of the fiber 2a is buried by pressing the fiber with a roller to the surface of the substrate 1, which has been softened when the substrate 1 is formed through extension forming, press forming or cast forming. The conductive article is obtained. Only a part of the fiber 2a is buried by the application of pressure, and there is other part still remained not buried in this method, achieving the desirable conductive layer 2.

In the sixth method, resin is molded through injection molding after the metal mold for the injection molding is sprayed with the ultra fine conductive carbon fiber 2a. The conductive article, in which the substrate 1 formed through the injection molding is fixed on the surface, is obtained. Not all the fibers are buried in the substrate 1, leaving some fiber on the surface in this method, acquiring the desirable conductive layer 2.

These methods mentioned above, where the ultra fine conductive carbon fiber 2a is sprayed to the softened substrate or the metal mold for injection molding, are very simple. These methods do not differ much from the methods widely known. It is easy to apply these methods for the continuous production.

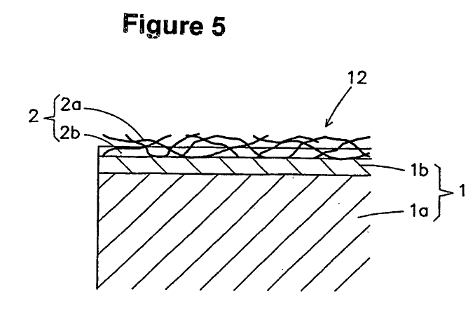

FIG. 5 is a partial cross-sectional view of the conductive article of the embodiment of this invention.

The substrate 1 has a substrate body 1a and a surface layer 1b laminated on the surface of the substrate body in the conductive article 12. The conductive layer 2 made of the dispersed ultra fine conductive fiber 2a is formed on the surface of the surface layer 1b. A part (either the edge part or the middle part of the fiber) of the ultra fine conductive fiber 2a of the conductive layer 2 is fixed on the surface layer 1b with the binder layer 2b and the other part protrudes from the surface layer 1b, with the ultra fine conductive fibers 2a in contact with each other. The surface layer 1b and the conductive layer 2 can be formed on both surfaces of the substrate body 1a.

The substrate body 1a is made of the same material as that of the substrate 1. The same resin used as the substrate body 1a or the different resin, but with the mutual-solubility is used for the surface layer 1b. The surface layer 1b can be an anti-weathering surface layer with a ultra-violet ray absorbent for improving the durability against weathering of the substrate body 1a, a light diffusion layer with a light diffusion material for forming a light diffusion article, or a surface layer with contact-durability with silica for improving the contact-durability of the article. That is, the surface layer 1b is formed to improve the properties of the substrate body 1a. The appropriate thickness of the surface layer 1b is 20-300 μm. The ultra fine conductive fiber 2a can be directly fixed to the surface layer 1b, omitting the binder layer 2b.

The conductive article 12 described above can be efficiently produced through the following methods. That is, the binder is solved into a volatile solvent. The ultra fine conductive fiber 2a is equally dispersed in this solution, making a coating solution. The coating solution is applied to the surface of the surface layer 1b made of the same thermo-plastic film as that of the substrate body 1a or the different thermo-plastic film with the mutual-solubility, and then, the coating solution is dried, forming a conductive film with the conductive layer 2. The conductive film is placed and pressed on the substrate body 1a through thermo-pressing or roll pressing, forming the conductive article 12. The ultra fine conductive fiber protrudes out from the binder with its spontaneous force of spring back when the thermo-pressing is applied. The desirable conductive layer 2 can be obtained by this method.

The article with the surface layer 1b laminated on the substrate body 1a is formed through simultaneous extrusion, pressing or coating. The conductive article 12 can be obtained when the coating solution is applied to and dried on the surface layer 1b of the article, when heat is applied after the application and drying of the coating solution on the surface layer 1b of the article, when the transfer is performed on the surface layer 1b of the article, or when the binder solution is applied on the surface layer 1b of the article.

The following examples illustrate embodiments of the invention, but should not be viewed as limiting the scope of the invention.

### EXAMPLES

### Example 1

The coating solution is prepared by the following procedure. Seven weigh portion of powdered vinylchloride resin as the thermo-plastic resin, 0.5 weigh portion of multi-layered carbon nanotube product of Tsinghua-Nafine Nano-Powder Commercialization Engineering Center, with the average outer diameter of 10 nm), and 0.2 weigh portion of alkyl ammonate solution of acid polymer as a disperser is added to the 100 weigh portion of cyclohexanon used as a solvent.

This coating solution is applied to the surface of a polycarbonate resin plate (with the thickness of 3 mm, the light transmission of 90.0%, and the haze of 1.0%), a product of Takiron Co. Ltd. The plate is pressed with the pressure of 30 kg/cm² in the temperature of 220° C. after the coating solution is dried and hardened. The transparent conductive polycarbonate resin plate with the conductive layer with the thickness of 190 nm is obtained.

The conductive layer of the resin plate is observed to acquire the estimated content by a transmission electron microscopy (a product of Nihon Denshi Kogyo Corp., JEM-2010). The estimated content is 14 mg/m².

The surface resistivity of the conductive layer is measured by Hilester produced by Mitsubishi Kagaku, and the light transmission by spectrometer UV-3100P produced by Shimazu Seisakusho. The surface resistivity is 7.7×10⁷Ω/□ and the light transmission is 92.8%.

The light transmission and the haze of the transparent conductive polycarbonate resin plate are measured by a direct reading haze computer HGM-2DP. The light transmission is 83.0% and the haze is 2.0%.

Furthermore, the conductive layer of the transparent conductive polycarbonate resin plate is observed by a transmission electron microscopy. The carbon nanotube is dispersed very well. Although the carbon nanotube is somewhat bent, each carbon nanotube is separated from other tubes without intensely intertwining with each other. The tubes are equally dispersed and simply crossing, making contact, with each other.

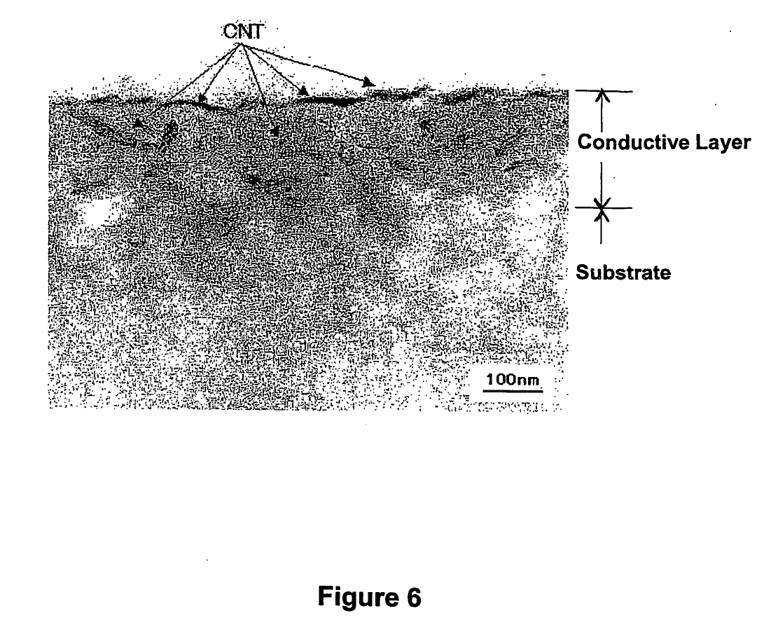

The conductive layer of the transparent conductive polycarbonate resin plate is vertically cut, and its edge is observed by a transmission electron microscopy. The carbon nanotube is dispersed, with a part of the tube protruding from the conductive layer, as seen from FIG. 6. Also, it is observed that a part of the carbon nanotube is buried in the conductive layer.

### Example 2

The coating solution is prepared by the following procedure. Single-layered Carbon nanotube (synthesized by referring to Chemical Physics Letters, 323 (2000) P 580 to 585, with the diameter of 1.3 to 1.8 nm) and the co-polymer between poly oxy-ethylene and poly oxy-propylene as disperser are added to the mixture of isopropylene alcohol and water (with the compound ration of 3:1) as a solvent. The carbon nanotubes content was 0.003 wt %, and the disperser content was 0.05 wt %.

This coating solution is applied to the surface of a polyethyleneterephtalate film with the thickness of 100 μm (with the light transmission of 94.5%, and the haze of 1.5%). After drying the solution, the film is applied with the urethane acrylate solution diluted to 1-600^{th} with methyl isobutyl ketone, and then dried. The transparent conductive polyethyleneterephtalate film with the conductive layer of the thickness of 47 nm is obtained.

The conductive layer of the film is observed to acquire the estimated content by a scanning electron microscopy (a product of Hitachi Seisakusho, S-800). The estimated content is 72.7 mg/m².

The surface resistivity and the light transmission of the conductive layer are measured by the same method used in the example 1. The surface resistivity is 5.4×10²Ω/□ and the light transmission is 90.5%.

The light transmission and the haze of the transparent conductive polyethyleneterephtalate film are measured by the same method used in example 1. The light transmission is 85.8% and the haze is 1.8%.

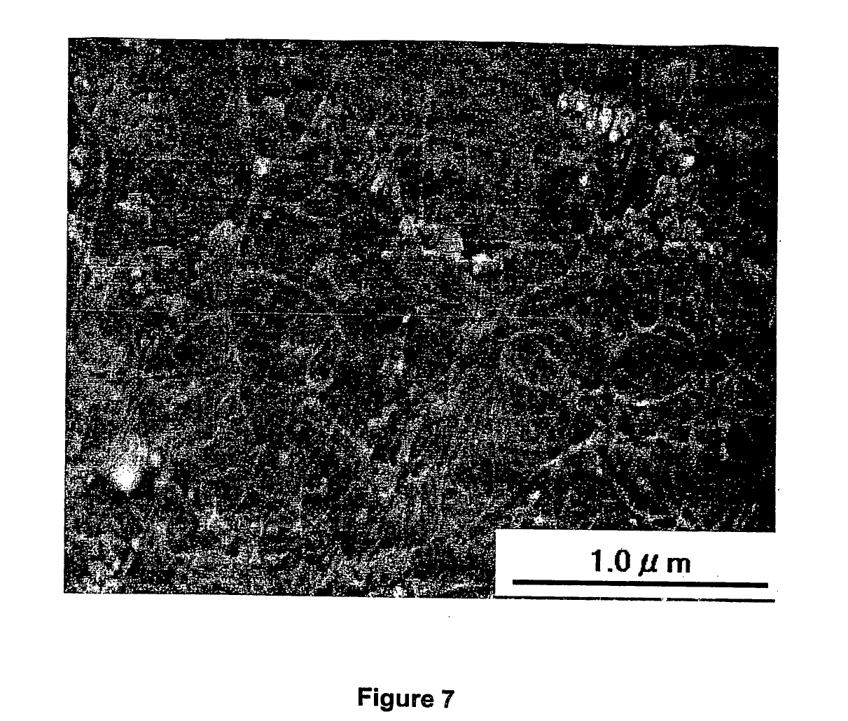

Furthermore, the surface of the conductive layer of the transparent conductive polyethyleneterephtalate film is observed by a scanning electron microscopy. The carbon nanotube is dispersed very well, as shown in FIG. 7. A plurality of the carbon nanotubes is dispersed, with each tube separated from other tubes, yet the tubes are in contact, simply crossing each other. The cross-section of the conductive layer of the transparent conductive polyethyleneterephtalate film is observed by a scanning electron microscopy. The carbon nanotube protruding from the conductive layer is observed.

### Comparative Example 1

The coating solution used in the example 1 is applied to the surface of a polycarbonate resin plate used in the example 1. The transparent conductive polycarbonate resin plate with the conductive layer of the thickness of 300 nm is obtained. The estimated content of the carbon nanotube in the conductive layer of the resin plate is measured by the same method used in the example 1. The estimated content is 22 mg/m².

The surface resistivity and the light transmission of the conductive layer of the transparent conductive polycarbonate resin plate are measured by the same method used in the example 1. The surface resistivity is 2.4×10¹¹Ω/□ and the light transmission is 84.5%. The light transmission and the haze of the transparent conductive polycarbonate resin plate are measured by the same method used in example 1. The light transmission is 6.3% and the haze is 2.0%.

Furthermore, the surface of the conductive layer of the transparent conductive polycarbonate resin plate is observed by a transmission electron microscopy. The carbon nanotube is dispersed very well. Although the carbon nanotube is somewhat bent, each carbon nanotube is separated from other tubes without intensely intertwining with each other. The tubes are equally dispersed and simply crossing, making contact, with each other.

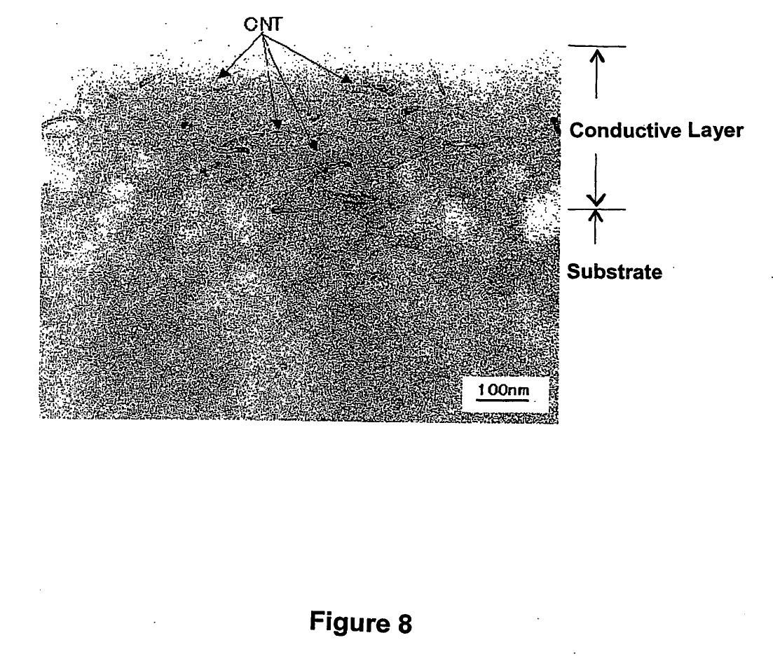

The conductive layer of the transparent conductive polycarbonate resin plate is vertically cut, and its edge is observed by a transmission electron microscopy. The entire carbon nanotube is buried in the conductive layer, as seen from FIG. 8. The nanotube does not protrude or expose itself from the surface of the conductive layer.

The estimated content of the carbon nanotube in the conductive layer is 14 mg/m² in the example 1 and 22 mg/m² in the comparative example 1. Although the example 1 has the smaller estimated content, the surface resistivity of the example 1 is 7.7×10⁷Ω/□, reduced by four-digit from that of the comparative example 1, where the surface resistivity is 2.4×10¹¹Ω/□. Since the carbon nanotube protrudes from the surface with the spring-back force pushing aside the softened binder in the conductive layer when the thermo-pressing is applied to the conductive layer, the insulating material for the electricity between the carbon nanotubes disappears in the example 1, leading to the low resistivity. It can also be understood by observing the photographs (FIGS. 6 and 8), which show the fact that the carbon nanotube protrudes from the substrate in the example 1, while the carbon nanotube is buried in the substrate in the comparative example 1. The light transmission is improved as the estimated content of the carbon nanotube is decreased. There is no big difference in the haze between the example 1 and the comparative example 1, acquiring the excellent transparent article in both examples.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims.

1. A conductive article comprising:
a substrate; and
a conductive layer formed on a surface of the substrate and comprising fine conductive fibers that are dispersed in the conductive layer,
wherein a portion of at least some of the fibers is fixed to the substrate and other portion of said at least some of the fibers protrude from a top surface of the conductive layer, and the fibers are arranged to be electrically in contact with each other.

2. The conductive article of claim 1, wherein the fibers are electrically in contact each other at the portions protruding form the top surface or at the portions fixed to the substrate.

3. The conductive article of claim 1, wherein the substrate comprises a substrate body and a surface layer, and the portions of the fibers fixed to the substrate are fixed to the surface layer.

4. The conductive article of claim 1, wherein the portion of the fibers fixed to the substrate are an end part of the fibers or a middle part of the fibers.

5. The conductive article of claim 1, wherein each of the fibers is separated form other fibers, and when the fibers form a plurality of bundles of fibers each bundle of the fibers is separated from other bundles.

6. The conductive article of claim 1, wherein the fibers are carbon fibers.

7. The conductive article of claim 6, wherein the carbon fibers are carbon nanotubes.

8. The conductive article of claim 1, wherein the thickness of the conductive layer is from 5 to 500 nm.

9. The conductive article of claim 1, wherein the surface layer is formed of a curable resin.

10. The conductive article of claim 1, wherein the surface layer is formed of a thermoplastic resin.

11. The conductive article of claim 1, wherein the conductive article has a surface resistivity of 10⁰ to 10¹¹Ω/□.

12. The conductive article of claim 1, wherein the conductive layer has a 550 nm light transmittance of at least 50% and a surface resistivity of from 10⁰ to 10⁵Ω/□.

13. A method of forming a conductive article comprising:
forming a conductive layer on a surface of the substrate, wherein said layer comprises fine conductive fibers that are dispersed, and a portion of at least some of the fibers is fixed to the substrate and other portion of said at least some of the fibers protrude from a top surface of the conductive layer, and the fibers are arranged to be electrically in contact with each other.

14. The method of claim 13, wherein the fibers are electrically in contact each other at the portions protruding form the top surface or at the portions fixed to the substrate.

15. The method of claim 13, wherein the substrate comprises a substrate body and a surface layer, and the portions of the fibers fixed to the substrate are fixed to the surface layer.

16. The method of claim 13, wherein the portion of the fibers fixed to the substrate are an end part of the fibers or a middle part of the fibers.

17. The method of claim 13, wherein each of the fibers is separated form other fibers, and when the fibers form a plurality of bundles of fibers each bundle of the fibers is separated from other bundles.

18. The method of claim 13, wherein the fibers are carbon fibers.

19. The method of claim 18, wherein the carbon fibers are carbon nanotubes.

20. The method of claim 13, wherein the thickness of the conductive layer is from 5 to 500 nm.

21. The method of claim 13, wherein the surface layer is formed of a curable resin.

22. The method of claim 13, wherein the surface layer is formed of a thermoplastic resin.

23. The method of claim 13, wherein the conductive article has a surface resistivity of from 10⁰ to 10¹¹Ω/□.

24. The method of claim 13, wherein the conductive layer has a 550 nm light transmittance of at least 50% and a surface resistivity of from 10⁰ to 10⁵Ω/□.
